(19) United States
(12) Patent Application Publication
(10) Pub. No.: US 2019/0236735 A1
(43) Pub. Date: Aug. 1, 2019

(54) DISTRIBUTION AND SALES SYSTEM FOR PRODUCTS AND SERVICES

(71) Applicant: Mark A. Aspenson, Waterloo, IA (US)

(72) Inventor: Mark A. Aspenson, Waterloo, IA (US)

(21) Appl. No.: 16/380,237

(22) Filed: Apr. 10, 2019

Related U.S. Application Data
(63) Continuation of application No. 14/644,627, filed on Mar. 11, 2015.
(60) Provisional application No. 61/951,298, filed on Mar. 11, 2014.

(51) Int. Cl. G06Q 50/18; G06Q 30/06

(52) U.S. Cl. CPC G06Q 50/184; G06Q 30/0635

(57) ABSTRACT

A distribution and sales system includes a master entity that owns the rights to various products and services and a plurality of management tiers tied together by an electronic network. The management tiers pay an ownership fee to the master entity and in return receive ownership rights that permit them to sell goods and services in a territory, sub-territory, or portion of a sub-territory and to sell different ownership rights to lower management tiers. A lowest management tier has a warehouse, distributes products and receives a service and handling fee.

### CROSS REFERENCE TO RELATED APPLICATION

This application is a Continuation of U.S. Ser. No. 14/644,627 filed on Mar. 11, 2015, which claims the benefit of the priority of U.S. Provisional Ser. No. 61/951,298 filed on Mar. 11, 2014, the contents of these applications are hereby incorporated by reference in their entirety.

### BACKGROUND OF THE INVENTION

This invention is directed to a system for selling and distributing products and services and more particularly to a system that provides incentives to make sales and efficiencies in distributing product.

The sale and distribution of products and services is well known. Presently, most systems create a competitive environment where sales individuals in the same organization compete against one another and are not rewarded financially for assisting other sales representatives. As a result, there is little incentive to assist others. In addition, the distribution of products from the manufacturer to a customer is often inefficient as product is either shipped in less than full loads or a full load is directed to multiple delivery locations. The current process to distribute products goes through multiple brokers, distributors and sales personal. As a result, a need exists for a system that addresses these deficiencies.

An objective of the present invention is to provide a system where all members benefit from the sale of a product or service.

Another objective of the present invention is to provide a system where products are delivered more efficiently. These and other objectives will be apparent to one of ordinary skill in the art based upon the following written description.

### SUMMARY OF THE INVENTION

A distribution and sales system includes a master entity that owns the rights to various products and services and a plurality of management tiers tied together by an electronic network.

The management tiers pay an ownership fee to the master entity and in return receive ownership rights that permit them to sell goods and services in a territory, sub-territory, or portion of a sub-territory and to sell different ownership rights to lower management tiers. A lowest management tier has a warehouse, distributes products and receives a service and handling fee.

### BRIEF DESCRIPTION OF THE DRAWINGS

FIG. 1 is a schematic diagram of an environment for a sales and distribution system;

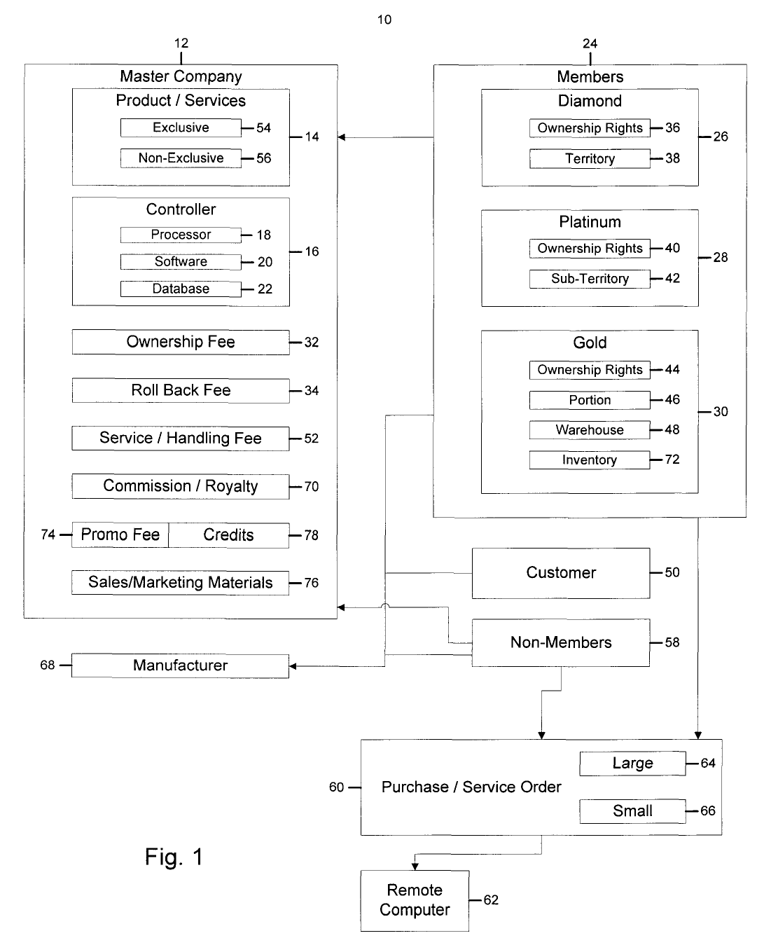

FIG. 2 is a flow diagram for a creation of a sales and distribution system;

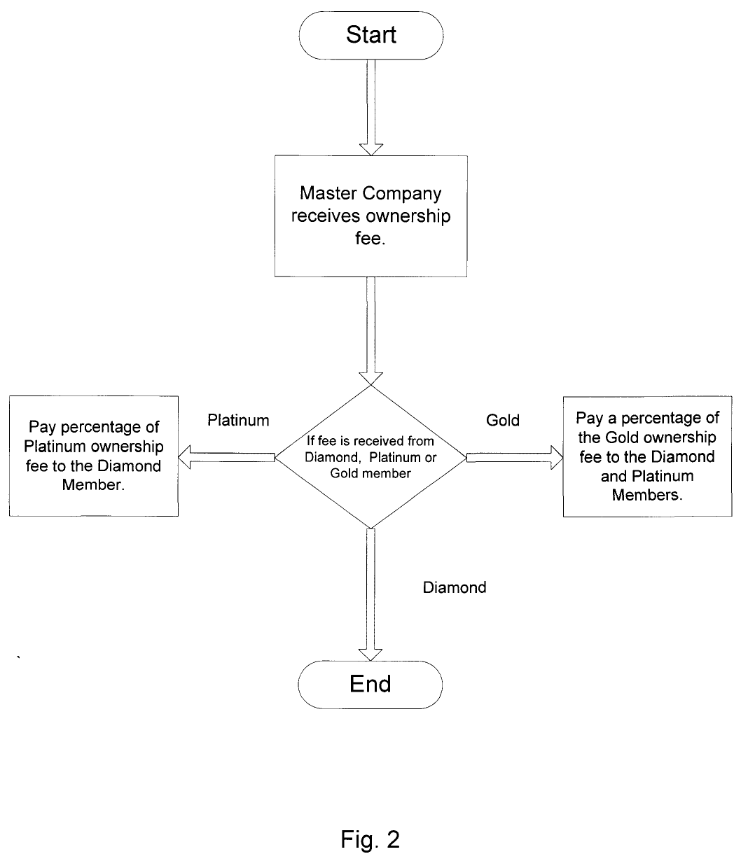

FIG. 3 is a flow diagram for an operation of a sales and distribution system; and

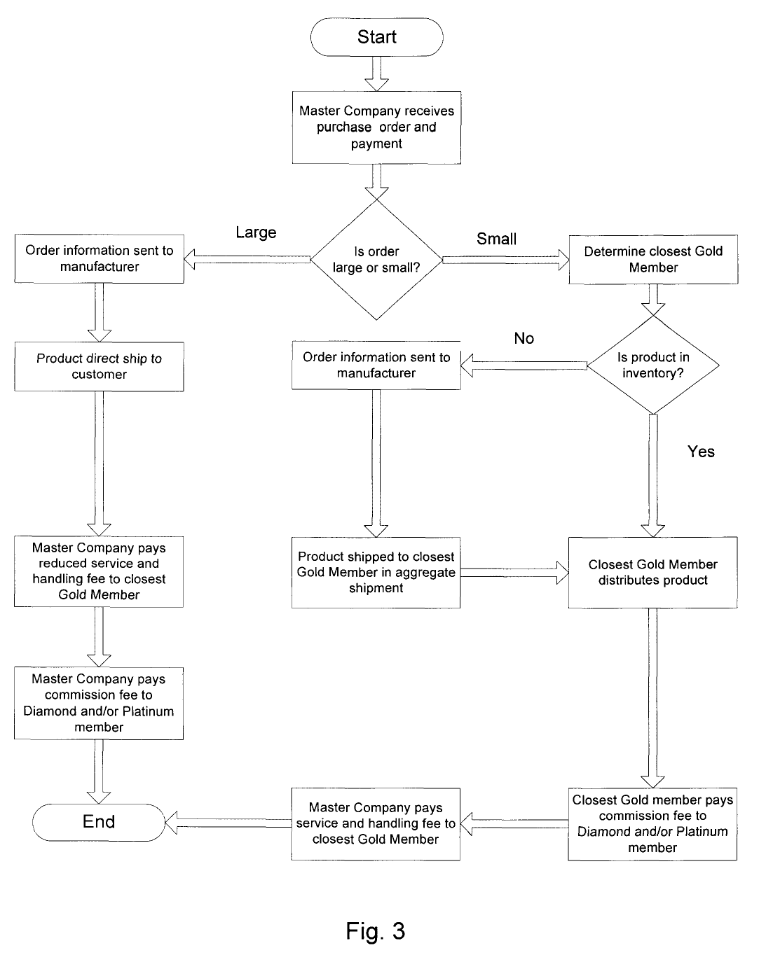

FIG. 4 is a flow diagram for an operation of sales and marketing for branding products and services.

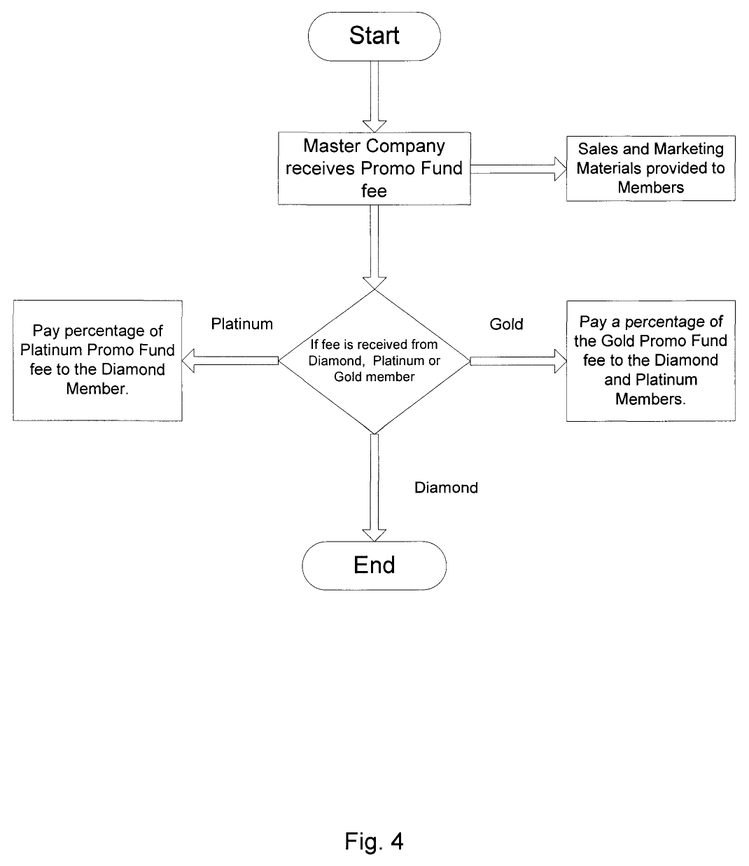

### DETAILED DESCRIPTION OF THE PREFERRED EMBODIMENT

Referring to the Figures/a distribution and sales system 10 includes a master company or entity 12. The master company 12 is comprised of one or more companies that offer products and/or services 14 or own rights to various products/services 14. If more than one company is present, one company may be designated as the master company 12, or a separate entity may be formed as the master company 12. The master company 12 has a controller 16 with a processor 18, software 20 and a database 22 that is connected to an electronic network.

The system 10 also includes a plurality of management tiers or members 24. For example, the system 10 may include a plurality of first tier or diamond 26 members who are managed by the master company 12. A plurality of second tier or platinum 28 members are managed by a diamond 26 member. Finally, a plurality of third tier or gold 30 service center members are managed by the platinum 26 members.

To become a member 24, each entity pays an ownership fee 32 to the master company 12. The amount of the ownership fee 32 is based upon whether a member 24 is a diamond 26, platinum 28 or gold 30 member. The master company retains all ownership fees 32 paid by diamond 26 members. A percentage of the ownership fee 32 paid by a platinum 28 member is distributed to the diamond 26 member as a roll back fee 34. Ownership fees 32 paid by gold 30 members include a percentage that is distributed to both the diamond 26 and platinum 28 members as a roll back fee 34. Typically, ownership fees 32 are higher for members 24 closer to the master company 12 and the roll back fees 34 or percentages are set to allow the diamond 26 and platinum 28 members to recoup their ownership fee 32 based upon the number of lower tier members 24 in the system.

The master company 12 sells ownership rights 36 to the diamond 26 members. The ownership rights 36 permit the diamond 26 members to sell products and services 14 within a territory 38 and to sell diamond 26 ownership rights 40 to platinum 28 members within the territory 38. The ownership rights 40 sold to platinum 28 members permit the platinum 28 members to sell the products and services 14 within a sub-territory 42 and to sell gold 30 ownership rights 44 to gold 30 service members within the sub-territory 42. The ownership rights 44 for the gold 30 members permits the sale of products and services 14 within a portion 46 of the sub-territory 42.

The master company 12 is responsible for managing and training the diamond 26 members. The diamond 26 members are responsible for managing and training the platinum 28 members. Similarly, the platinum 28 members are responsible for training and managing the gold 30 members.

The gold 30 members differ from the diamond 26 and platinum 28 members in several ways. First, the gold 30 members have a warehouse 48 for storing product 14. Gold 30 members are also responsible, in addition to selling products and services 14 in a portion 46 of the sub-territory 42 and for the distribution of products and/or providing services for purchasing customers 50. In return for providing distribution and services, gold 30 members are paid a service and handling fee 52.

The products and services 14 may be exclusive 54 or non-exclusive 56. Exclusive products 54 are sold only by members 24 while non-exclusive products 56 are sold by both members 24 and non-members 58 such as suppliers and wholesalers. Sales to non-members 58 preferably are sold in truckload increments of ⅓, ½ and full loads. When sales are made to non-members 58, a commission/royalty is paid to members 24 based upon whether the non-member 58 is located within a portion 46, the sub-territory 42, and the territory 38.

In operation, a sale of a product and/or service can be made by any member 24. When a sale occurs, a purchase/service order 60 is entered into a remote computer 62 by a member 24 and then transmitted via the electronic network to the controller 16 at the master company 12. The order 60 includes information on the member 24 who made the sale, the products 14 sold, the size of the order, the customer and the delivery location. The order 60 is stored in the database 22 by the processor 18. The processor also determines whether the order is to a member 24 or to a non-member 58, and whether the order is large 64 or small 66. Small retail sales will be service by gold 30.

Typically, a large order 64 fills a semi or tractor trailer while a small load 66 fills only a portion of a semi or tractor trailer.

If the order 60 is from a non-member 58, the processor 18 sends an instruction to a manufacturer 68 of the product to deliver the product 14 ordered to the non-member 58.

The processor 18 also calculates and distributes a lowered service and handling fee 52 to the gold 30 member who has gold 30 ownership rights 44 to the portion 46 of the sub-category 42 where the non-member 58 is located. The controller 16 will also calculate and distribute commission/royalty 70 to members 24.

If the order 60 is from a member 24, the controller 16 first determines if the order 60 is large 64 or small 66. If small 66, the controller checks the inventory 72 of the closest gold 30 member to determine if the product 14 is in stock. If in stock, the gold 30 member pays a commission to the member 24 who made the sale. If the order is large 64, the controller 16 sends instructions to the manufacturer 68 to deliver the product 14 to the gold 30 member closest to the location of the purchasing customer 50 or direct ships to the customer. The controller 16 calculates and distributes the service and handling fee 52 to the closest gold 30 member who delivers the product 14 to the customer 50. The controller 16 also calculates and distributes a commission/royalty 70 to the members 24 based upon the type of member 24 that makes the sale. If the sale is made by a diamond 26 member, the full commission 70 is distributed to the diamond 26 member. If a platinum 28 member makes the sale, a percentage of the commission fee 70 is sent to the diamond 26 member with the remainder going to the platinum 28 member. If the gold 30 member makes the sale, a percentage of the commission fee 70 is distributed to both the diamond 26 and platinum 28 members with the remainder going to the gold 30 member.

The controller 16 also calculates an annual promo fund fee 74 that is paid to the master company 12 by the members 24. The promo fund fee 74 is based on the benefits and services offered by the master company 12, a percentage of which is used for branding the products and services 14. A percentage of the promo fund fee 74, calculated by the controller, is returned to the members 24 in the form of sales and marketing materials 76. Also, a percentage of the promo fund fee 74 paid by platinum 28 members will roll back to the diamond 26 members. Also, a percentage of the promo fund fee 74 paid by gold 30 members will roll back to the diamond 26 and platinum 28 members to compensate for training and the like. Sales and marketing materials 76 will be purchased in bulk and distributed at cost plus shipping. In one embodiment, members 24 can earn credits 78 based on performance.

What is claimed is:

1. A distribution and sales system, comprising:
a master entity that owns rights to various products and services and that has a controller with a processor connected to an electronic network;
a plurality of management tiers having different management responsibilities, territories, and ownership rights;
wherein ownership fees are paid by the plurality of management tiers and received by the master entity based upon the different responsibilities, territories, and ownership rights and the processor calculates roll back fees from the master entity and the master entity distributes the roll back fees to the plurality of management tiers based upon the different management responsibilities, territories and ownership rights;
a lowest management tier has a facility to distribute products and services to purchasing customers;
purchase/service orders are made through a remote computer connected to the processor of the master entity and the master entity processor determines whether an order is large, small, exclusive, non-exclusive and selects a distribution means based upon the determination;
where the processor of the master entity sends instructions to a manufacturer to deliver an ordered product to the lowest management tier closest to a location of a purchasing customer.

2. The system of claim 1 wherein the ownership fees paid to the master entity permit the management tiers to sell the various products and services in one of a territory, a sub-territory and a portion of a sub-territory.

3. The system of claim 1 wherein ownership rights granted by the master entity permit a management tier to sell different ownership rights to a different management tier.

4. The system of claim 1 wherein the products and services are exclusive.

5. The system of claim 1 wherein the master entity processor determines an amount and distributes commissions/royalties, promo funds, and credits to management tiers based upon the purchase/service order.

6. The system of claim 1 wherein the plurality of management tiers includes at least one tier that has a warehouse containing at least one of the various products.

7. The system of claim 1 wherein the master entity determines where to send purchase/service order for fulfillment.
